(19) United States
(12) Patent Application Publication
(10) Pub. No.: US 2026/0332073 A1
(43) Pub. Date: Oct. 22, 2026

(54) Motor Control Apparatus and Electric Vehicle

(71) Applicant: ASTEMO, LTD., Tokyo (JP)

(72) Inventors: Shun TANIGUCHI, Tokyo (JP); Kentaro MATSUO, Hitachinaka-shi, Ibaraki (JP); Takafumi HARA, Hitachinaka-shi, Ibaraki (JP); Toshiyuki AJIMA, Tokyo (JP)

(21) Appl. No.: 19/110,628

(22) PCT Filed: Oct. 16, 2023
(86) PCT No.: PCT/JP2023/037384

§ 371 Date: Mar. 11, 2025

(30) Foreign Application Priority Data
Nov. 9, 2022 (JP) 2022-179289

(51) Int. Cl. H02P 21/05; B60L 15/00; H02P 21/22; H02P 27/12

(52) U.S. Cl. CPC H02P 21/05; B60L 15/007; H02P 21/22; H02P 27/12; B60L 2210/40

(57) ABSTRACT

Provided is a motor control apparatus that randomly selects a plurality of carrier frequency candidates and that disperses harmonic components, the motor control apparatus being capable of suppressing electromagnetic noise by widening the dispersion of the harmonic components while suppressing the heat generation amount of a switching element of an inverter. The motor control apparatus controls an inverter that supplies AC power to an AC motor and includes: a carrier frequency generation unit that selects, based on a random number, each of a plurality of carrier frequency candidates at a predetermined ratio and that outputs the selected carrier frequency candidate as a carrier frequency; a carrier wave generation unit that, based on the selected carrier frequency, generates a carrier wave; and a PWM controller that outputs a PWM signal based on the carrier wave to an inverter, wherein the predetermined ratio is determined based on the frequencies of the plurality of carrier frequency candidates and on a predetermined maximum average switching frequency.

### TECHNICAL FIELD

The present invention relates to a motor control apparatus that suppresses electromagnetic noise and harmonics which are generated in a motor driving inverter, and an electric vehicle equipped with the motor control apparatus.

### BACKGROUND ART

As a conventional technique for suppressing electromagnetic noise and harmonics which are generated in a motor driving inverter by dispersing a carrier frequency, the PWM waveform generation device of Patent Literature 1 is known. For example, the Abstract of Patent Literature 1 discloses, as a problem, “To provide, in a PWM control inverter device mounted in an air conditioner, a PWM waveform generation device that is capable of suppressing particularly harsh carrier sounds (note by the applicant: the same meaning as “electromagnetic noise” according to paragraph [0009] etc. of Patent Literature 1) without significantly increasing the carrier frequency and that is capable of equivalently reducing the noise of the air conditioner.”

Further, claim 5 of Patent Literature 1 discloses: “The PWM waveform generation device according to claim 2, wherein the second carrier frequency-switching means includes: random order setting means for randomly setting a selection order related to a plurality of carrier frequencies of the carrier frequency setting means; and fifth carrier frequency-switching means for, using appropriate timing, selecting and switching the carrier frequency from among the plurality of carrier frequencies of the carrier frequency setting means, according to the random selection order set by the random order setting means.”

As described above, Patent Literature 1 proposes a PWM waveform generation method with which harmonic components are dispersed by sequentially selecting one of a plurality of carrier frequency candidates according to selection frequencies weighted in a random order with random timing, thus reducing electromagnetic noise.

### CITATION LIST

### Patent Literature

PTL 1: JP 9-47026 A

### SUMMARY OF INVENTION

### Technical Problem

The approximate heat generation amount of a switching element of an inverter is determined according to a temporal average value fₐᵥₑ of carrier frequencies, but Patent Literature 1 makes no mention at all of the technical concept of suppressing the heat generation amount of the switching element by controlling the magnitude of the average value fₐᵥₑ. Therefore, as a result of the carrier frequency dispersion of Patent Literature 1, it is conceivable that motor control is inappropriate from the viewpoint of suppressing the heat generation amount of the switching element, and in such a case, the possibility of causing failure of the inverter due to excessive heat generation of the switching element cannot be excluded.

As a method for suppressing the heat generation amount by the switching element under the condition that there are a plurality of carrier frequency candidates, a method for uniformly reducing the frequency of each carrier frequency candidate is also conceivable. However, because it is necessary to set each carrier frequency candidate under the constraints shown in FIG. 1, it is difficult to uniformly reduce the frequency of each carrier frequency candidate. That is, the upper limit of the maximum value fₘₐₓ of the carrier frequency is determined according to the processing performance of the motor control apparatus (in particular, the built-in microcomputer), and the lower limit of the minimum value fₘᵢₙ of the carrier frequency is determined according to the response speed under the specifications required for the motor control apparatus. Therefore, each carrier frequency candidate needs to be set within a range from the minimum value fₘᵢₙ to the maximum value fₘₐₓ. Therefore, it is effective to intensively arrange the carrier frequency candidates in the vicinity of the minimum value fₘᵢₙ of the carrier frequency in order to reduce the average value fₐᵥₑ of the carrier frequency that affects the heat generation amount of the switching element, but in this case, there is a possibility that the dispersion of the harmonic components becomes insufficient and the electromagnetic noise increases.

Therefore, an object of the present invention is to provide a motor control apparatus that randomly selects a plurality of carrier frequency candidates and that disperses harmonic components, the motor control apparatus being capable of suppressing electromagnetic noise by widening the dispersion of the harmonic components while suppressing the heat generation amount of a switching element of an inverter.

### Solution to Problem

A motor control apparatus for controlling an inverter that supplies AC power to an AC motor, the motor control apparatus including: a carrier frequency generation unit that selects, based on a random number, each of a plurality of carrier frequency candidates at a predetermined ratio and that outputs the selected carrier frequency candidate as a carrier frequency; a carrier wave generation unit that, based on the selected carrier frequency, generates a carrier wave; and a PWM controller that outputs a PWM signal based on the carrier wave to an inverter, wherein the predetermined ratio is determined based on the frequencies of the plurality of carrier frequency candidates and on a predetermined maximum average switching frequency.

### Advantageous Effects of Invention

With the motor control apparatus of the present invention, it is possible to suppress the electromagnetic noise by widening the dispersion of the harmonic components while suppressing the heat generation amount of the switching element of the inverter.

### BRIEF DESCRIPTION OF DRAWINGS

FIG. 1 is a graph illustrating carrier frequency constraints.

FIG. 2 is a functional block diagram representing an overall configuration of a motor drive system according to a first embodiment.

FIG. 3 is a functional block diagram representing a configuration of a carrier frequency generation unit according to the first embodiment.

FIG. 4 is a configuration diagram of a drive system of an electric vehicle according to a second embodiment.

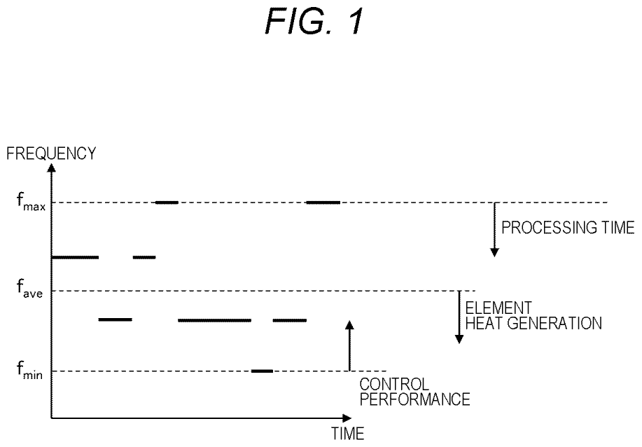

### DESCRIPTION OF EMBODIMENTS

Hereinafter, embodiments of the motor drive apparatus of the present invention will be described with reference to the drawings.

### First Embodiment

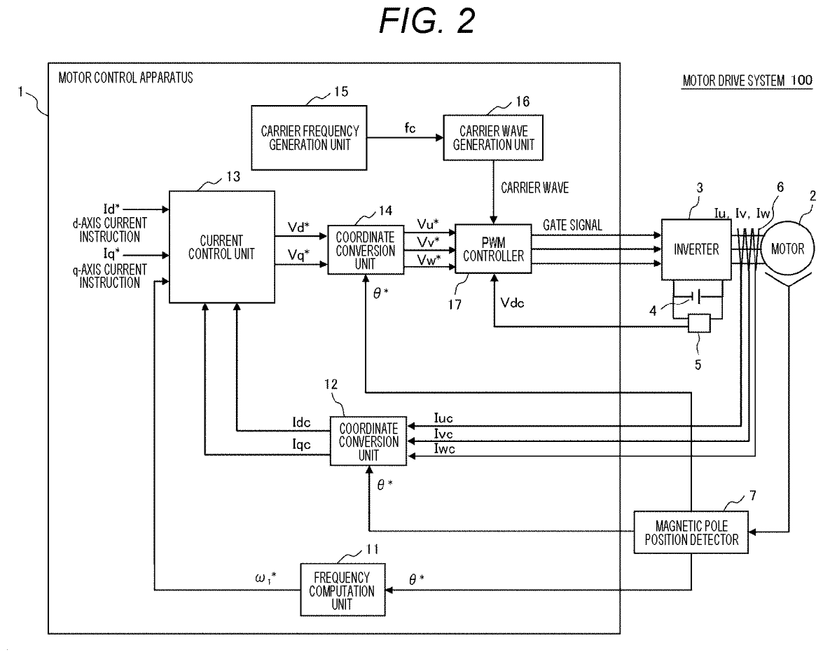

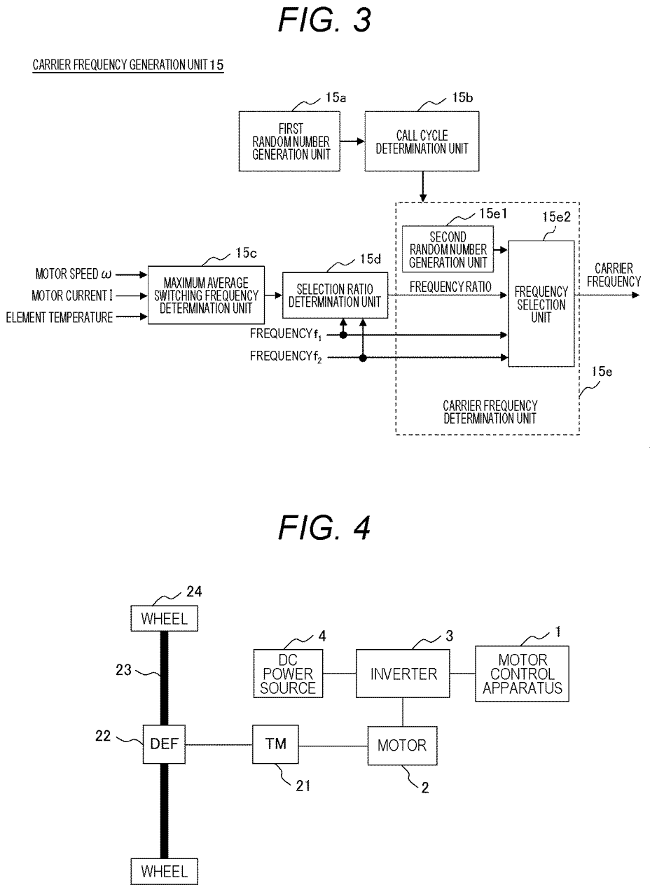

First, a motor control apparatus 1 according to a first embodiment of the present invention will be described with reference to FIGS. 2 and 3.

FIG. 2 is a functional block diagram representing an overall configuration of a motor drive system 100 according to this embodiment. As illustrated herein, the motor drive system 100 includes a motor control apparatus 1, a motor 2, an inverter 3, a DC power source 4, a DC voltage detector 5, a phase current detector 6, and a magnetic pole position detector 7. Hereinafter, among the configurations of the motor drive system 100, configurations other than that of the motor control apparatus 1 will be sequentially outlined, and then the motor control apparatus 1 will be described in detail.

The motor 2 is a permanent magnet synchronous motor (Permanent Magnet Synchronous Motor; PMSM) which is driven by AC power. Note that, in a case where an AC machine such as a synchronous reluctance motor, a permanent magnet synchronous generator, a winding-type synchronous machine, an induction motor, or an induction generator is used instead of the permanent magnet synchronous motor, the advantageous effects of the present invention described below can be obtained.

The inverter 3 is a power conversion device that converts DC power into AC power according to a gate signal (PWM signal) from the motor control apparatus 1 and supplies the AC power to the motor 2. The inverter 3 uses a plurality of semiconductor switching elements (IGBT, MOSFET, etc.) in order to convert DC power into AC power, and at that time, the temperature of each semiconductor switching element rises.

Note that, although not illustrated, each semiconductor switching element is provided with a temperature sensor, and the element temperature detected by each temperature sensor is also inputted to the motor control apparatus 1.

The DC power source 4 is a power supply that supplies DC power to the inverter 3. The DC power source 4 may be a battery or a power source that outputs DC power obtained by rectifying and smoothing commercial AC power.

The DC voltage detector 5 is a sensor that detects an output voltage of the DC power source 4 and outputs the output voltage as DC voltage information Vdc to the motor control apparatus 1.

The phase current detector 6 includes a Hall CT (Current Transformer) or the like, and is a sensor that detects three-phase currents Iu, Iv, and Iw of a U phase, a V phase, and a W phase, respectively, which are supplied from the inverter 3 to the motor 2, and that outputs the currents Iu, Iv, and Iw as current waveforms Iuc, Ivc, and Iwc, respectively, to the motor control apparatus 1.

The magnetic pole position detector 7 includes a resolver or the like, and is a sensor that detects the magnetic pole position of the motor 2 and outputs the magnetic pole position to the motor control apparatus 1 as magnetic pole position information θ.

### <Details of Motor Control Apparatus 1>

As illustrated in FIG. 2, the motor control apparatus 1 according to the present embodiment includes a frequency computation unit 11, a coordinate conversion unit 12, a current control unit 13, a coordinate conversion unit 14, a carrier frequency generation unit 15, a carrier wave generation unit 16, and a PWM controller 17. These units will be sequentially described hereinbelow. Note that, specifically, the motor control apparatus 1 is a computer including hardware such as a CPU or another computation device, a semiconductor memory or another storage device, and a communication device. The computation device then executes a desired program to implement each of the above-described functional units, but hereinafter, such a well-known technique will be appropriately omitted.

The frequency computation unit 11 computes speed information ω1 from magnetic pole position information θ detected by magnetic pole position detector 7, and outputs the speed information ω1. Note that, for example, a differential operation can be used for the computation here.

The coordinate conversion unit 12 uses the magnetic pole position information θ detected by the magnetic pole position detector 7 to perform coordinate conversion on the current waveforms Iuc, Ivc, and Iwc detected by the phase current detector 6, and outputs dq-axis current detection values Idc and Iqc.

The current control unit 13 computes and outputs appropriate dq-axis voltage command values Vd* and Vq* such that the dq-axis current command values Id* and Iq* inputted from a host device or the like match the dq-axis current detection values Idc and Iqc inputted from the coordinate conversion unit 12.

The coordinate conversion unit 14 uses the magnetic pole position information θ detected by the magnetic pole position detector 7 to perform coordinate conversion on the dq-axis voltage command values Vd* and Vq* inputted from the current control unit 13, and outputs three-phase voltage command values Vu*, Vv*, and Vw*.

The carrier frequency generation unit 15 outputs a carrier frequency fc effective for suppressing the heat and electromagnetic noise generated by the inverter 3. Details of the carrier frequency fc generated here will be described below.

The carrier wave generation unit 16 generates a carrier wave such as a triangular wave or a sawtooth wave on the basis of the carrier frequency fc outputted from the carrier frequency generation unit 15.

The PWM controller 17 computes a duty signal from the three-phase voltage command values Vu*, Vv*, and Vw* and the DC voltage information Vdc, compares the duty signal with the carrier wave, and outputs a gate signal (PWM signal) of each phase. The switching element of the inverter 3 is PWM-controlled according to the gate signal (PWM signal), whereby the motor 2 is rotationally controlled at the desired rotational speed according to a command from a host device or the like.

### <<Details of Carrier Frequency Generation Unit 15>>

Hereinafter, details of the carrier frequency generation unit 15, as well as the principle and advantageous effects of the present invention, which are the essence of the present invention, will be described.

FIG. 3 is an example of the functional blocks of a carrier frequency generation unit 15 according to this embodiment. As illustrated here, the carrier frequency generation unit 15 includes a first random number generation unit 15a, a call cycle determination unit 15b, a maximum average switching frequency determination unit 15c, a selection ratio determination unit 15d, and a carrier frequency determination unit 15e. These units will be sequentially described hereinbelow.

The first random number generation unit 15a generates a random number RN₁, which is a natural number. The random number RN₁ is, for example, any natural number from 1 to 8, and may be a pseudo random number generated using map referencing or linear congruence.

The call cycle determination unit 15b randomly determines a timing (hereinafter referred to as the “call cycle”) at which carrier frequency determination unit 15e (described below) is called based on random number RN₁ generated by the first random number generation unit 15a. This call cycle is, for example, a cycle obtained by multiplying a half cycle (fc/2) of the current carrier frequency fc by n (n is a natural number), and when the random number RN₁ generated by the first random number generation unit 15a is 3, 3fc/2 is determined as the call cycle, and when the random number RN₁ is 8, 4fc is determined as the call cycle. Note that the carrier frequency determination unit 15e described below allows continuous selection of the same carrier frequency fc as the previous carrier frequency. Therefore, the carrier frequency fc is not always updated in synchronization with the call cycle determined by the call cycle determination unit 15b.

Based on the motor speed ω, the motor current I=√(Id²+Iq²), the element temperature, and the like, the maximum average switching frequency determination unit 15c determines the maximum value of the average switching frequency so that the heat generation amount of the switching element can be suppressed to the extent that the inverter 3 does not fail.

Here, the maximum average switching frequency f_{ave_max} is determined as follows. For example, in a region where the motor speed w is small and the motor current I is large, the temperature rise of the switching element tends to increase, and thus the maximum average switching frequency f_{ave_max} is set to be lower than that in the normal state. Alternatively, in a case where the temperature of the switching element exceeds a predetermined value, the maximum average switching frequency f_{ave_max} is set to be lower than that in a normal state.

The selection ratio determination unit 15d determines the selection ratio of each of the plurality of prepared carrier frequencies fc based on the maximum average switching frequency f_{ave_max}. For example, in a case where two types of the first frequency f₁ and the second frequency f₂ (where f₁>f₂) are prepared as candidates of the carrier frequency fc, the selection ratio determination unit 15d limits, according to Formula 1, the selection ratio r₁ of the first frequency f₁ at which the heat generation amount of the switching element becomes larger. Note that the advantageous effect of limiting the selection ratio r₁ of the first frequency f₁ according to Formula 1 will be described below.

$$\begin{matrix}[ Expression 1 ] & \\ {r}_{1} < \frac{{f}_{1} ( 1 \text{?} \frac{{f}_{2}}{{f}_{ave \_ max}} )}{{f}_{1} - {f}_{2}} & ( Formula 1 )\end{matrix}$$

$$\text{?} \text{indicates text missing or illegible when filed}$$

The carrier frequency determination unit 15e is called when the call cycle determined by the call cycle determination unit 15b is reached, selects one of the plurality of prepared carrier frequency candidates within the allowable range of the selection ratio determined by the selection ratio determination unit 15d, and outputs the selected carrier frequency candidate as the carrier frequency fc. In order to implement this function, the carrier frequency determination unit 15e includes a second random number generation unit 15e1 and a frequency selection unit 15e2.

The second random number generation unit 15e1 generates a random number RN₂, which is a natural number. The random number RN₂ is, for example, any natural number from 1 to 100, and may be a pseudo random number generated using map referencing or linear congruence.

The frequency selection unit 15e2 selects one of the first frequency f₁ and the second frequency f₂ as the carrier frequency fc based on the random number RN₂ generated by the second random number generation unit 15e1 and the selection ratio r₁ determined by the selection ratio determination unit 15d. For example, the calculated value obtained by dividing the random number RN₂ by 100 is compared with the selection ratio r₁. When the calculated value is equal to or less than the selection ratio r₁, the first frequency f₁ is selected as the carrier frequency fc. When the calculated value is larger than the selection ratio r₁, the second frequency f₂ is selected as the carrier frequency fc. Because the random number RN₂ is a random number, the selection ratio of the first frequency f₁ asymptotically approaches the desired selection ratio r₁ by continuing the carrier frequency selection according to this method.

### <Effect of Formula 1>

Hereinafter, the reason why the average switching frequency fₐᵥₑ is equal to or less than the desired maximum average switching frequency f_{ave_max} according to Formula 1 will be described.

Because the time when the carrier frequency is selected is proportional to the reciprocal of the carrier frequency, Formula 2 holds.

$$\begin{matrix}[ Expression 2 ] & \\ \frac{1}{{f}_{ave}} = \frac{{r}_{1}}{{f}_{1}} + \frac{1 - {r}_{1}}{{f}_{2}} & ( Formula 2 )\end{matrix}$$

Formula 3 is obtained by solving Formula 2 for the selection ratio r₁.

$$\begin{matrix}[ Expression 3 ] & \\ {r}_{1} < \frac{{f}_{1} ( 1 \text{?} \frac{{f}_{2}}{{f}_{ave}} )}{{f}_{1} - {f}_{2}} & ( Formula 3 )\end{matrix}$$

$$\text{?} \text{indicates text missing or illegible when filed}$$

Here, Formula 1 is obtained by setting the average switching frequency fₐᵥₑ to be equal to or less than the maximum average switching frequency f_{ave_max}. Therefore, if the selection ratio r₁ of the first frequency f₁ is determined as per Formula 1, it is possible to realize the maximum average switching frequency f_{ave_max} or less.

It is thus possible to prevent the heat generation amount of the switching element from becoming larger than an assumed value.

In addition, in a case where the selection ratio is changed, the carrier frequency to be selected does not change, and hence only the selection ratio is changed without changing the carrier frequency itself which is to be selected in order to suppress the heat generation amount. As a result, it is not necessary to narrow the frequency selection range, and thus the degree of reduction of the harmonic dispersion effect is small. Therefore, when the average switching frequency is decreased, it is possible to enhance the harmonic dispersion effect as compared with a measure to uniformly lower the first frequency f₁ and the second frequency f₂.

Although the method for limiting the selection ratio r₁ according to Formula 1 has been described in the present embodiment, Formula 4 may be used instead of Formula 1.

$$\begin{matrix}[ Expression 4 ] & \\ {r}_{1} < \frac{{f}_{ave \_ max} - {f}_{2}}{{f}_{1} - {f}_{2}} & ( Formula 4 )\end{matrix}$$

Formula 4 does not take into account that the time during which the carrier frequency is outputted varies depending on the frequency, and is based on the assumption that the selected carrier frequency does not vary in duration irrespective of frequency. Because the calculation is simpler with this approach, in a case where the difference between the first frequency f₁ and the second frequency f₂ is small, even if the calculation is performed by Formula 4, a result substantially equivalent to Formula 1 can be obtained.

In the present embodiment, the example in which the maximum average switching frequency changes depending on the speed, the current, and the temperature of the semiconductor switching element of the inverter 3 has been described (see the input signal in FIG. 3), but the maximum average switching frequency may, assuming a worst case, be set at a fixed value. Alternatively, the selection ratio itself may also be calculated from the first frequency f₁, the second frequency f₂, and the fixed maximum average switching frequency and be set at a fixed value.

Furthermore, in the present embodiment, an example in which the call cycle is random has been described, but even in a case where the call cycle changes under a predetermined rule, similar advantageous effects can be obtained, although there is a possibility that harmonic components are generated due to regular carrier frequency switching.

As described above, with the motor control apparatus according to the present embodiment, it is possible to suppress the electromagnetic noise by widening the dispersion of the harmonic components while suppressing the heat generation amount of the switching element of the inverter.

### Modification

Although a case where candidates for the carrier frequency fc are binary has been described above, even if the candidates are ternary or quaternary, it is possible to suppress the heat generation amount in the inverter 3 by similarly considering the selection ratio. Hereinafter, a method for selecting the frequency ratio will be described by citing an example in which the carrier frequency candidates are ternary.

When the selection ratio of the first frequency f₁, which is a candidate for the carrier frequency fc, is r₁, the selection ratio of the second frequency f₂ (where f₁>f₂) is r₂, and the selection ratio of the third frequency f₃ (where f₂>f₃) is r₃ (where r₃=1−r₁−r₂), the time during which the carrier frequency fc is selected is proportional to the reciprocal of the carrier frequency, and thus Formula 5 holds.

$$\begin{matrix}[ Expression 5 ] & \\ \frac{1}{{f}_{ave}} = \frac{{r}_{1}}{{f}_{1}} + \frac{{r}_{2}}{{f}_{2}} + \frac{1 - {r}_{1} - {r}_{2}}{{f}_{3}} & ( Formula 5 )\end{matrix}$$

Formula 6 is obtained by solving Formula 5 for the frequency ratio r₁.

$$\begin{matrix}[ Expression 6 ] & \\ {r}_{1} = \frac{{f}_{1} ( {f}_{2} ( {f}_{3} - {f}_{ave} ) + {r}_{2} {f}_{ave} ( {f}_{2} - {f}_{3} ) )}{{f}_{2} {f}_{ave} ( {f}_{3} - {f}_{1} )} & ( Formula 6 )\end{matrix}$$

Therefore, the selection ratio determination unit 15d limits the selection ratio r₁ of the first frequency f₁ according to Formula 7. The relationship between Formulas 6 and 7 corresponds to the relationship between Formulas 3 and 1 in a case where the candidates for the carrier frequency fc are binary values.

$$\begin{matrix}[ Expression 7 ] & \\ {r}_{1} = \frac{{f}_{1} ( {f}_{2} ( {f}_{3} - {f}_{ave \_ max} ) + {r}_{2} {f}_{ave \_ max} ( {f}_{2} - {f}_{3} ) )}{{f}_{2} {f}_{ave \_ max} ( {f}_{3} - {f}_{1} )} & ( Formula 7 )\end{matrix}$$

Here, the selection ratio r₂ of the second frequency f₂ at the center among the three frequency candidates is preferably a small value considering the dispersion effect, and thus is fixed at, for example, 0.1 and used for the calculation of Formula 7. Alternatively, the selection ratio r₂ may be changed according to a condition by taking the electromagnetic noise measurement results as a reference. Nevertheless, if the selection ratio r₁ is limited according to Formula 7, the heat generation amount can be suppressed even in a case where frequency candidates are ternary. Note that, in a case where the frequency candidates are three values, Formula 8 may be used instead of Formula 7.

$$\begin{matrix}[ Expression 8 ] & \\ {r}_{1} < \frac{( {f}_{ave \_ max} - {f}_{3} ) + ( {f}_{3} - {f}_{2} ) {r}_{2}}{{f}_{1} - {f}_{3}} & ( Formula 8 )\end{matrix}$$

Formula 8 does not consider that the time during which the carrier frequency is outputted varies depending on the frequency, and is based on the premise that the duration does not vary irrespective of the selected carrier frequency. Because the calculation is simpler with this approach, in a case where the differences between f₁, f₂, and f₃ are small, even if the calculation is performed using Formula 8, a result substantially equivalent to that of Formula 7 can be obtained.

### Second Embodiment

Next, a second embodiment of the present invention will be described with reference to FIG. 4. Note that redundant descriptions of points in common with the first embodiment will be omitted.

FIG. 4 illustrates a configuration of a drive system of an electric vehicle according to the second embodiment of the present invention. As illustrated herein, the electric vehicle of the present embodiment includes a transmission 21, a differential gear 22, a drive shaft 23, and wheels 24 in addition to the motor control apparatus 1, the motor 2, the inverter 3, and the DC power source 4, which were described in the first embodiment.

The motor 2 is connected to the transmission 21. The transmission 21 is connected to the drive shaft 23 via a differential gear 22 and supplies power to the wheels 24.

Note that a configuration in which the transmission 21 is not provided and which is directly connected to the differential gear 22 or a configuration in which the motor 2 and the inverter 3 are applied to the front wheels and the rear wheels, respectively, may be adopted.

For automobiles, the requirements regarding motor noise are strict, and hence, in an automobile application, the carrier frequency cannot be set low in light of the need to respond to such requirements. Therefore, it can be said that the advantageous effects of the present invention are more noticeable when applied to automobiles than in other applications. Similarly, in rail travel, the requirements regarding motor noise are strict as in the case of automobiles, and the advantageous effects of the present invention are easily exhibited.

Applying the present invention enables, in automobile and rail travel, a harmonic dispersion effect using random PWM while restricting the heat generation of the semiconductor switching element of the inverter 3 to be equal to or less than a predetermined value. This configuration leads to improvements in the ride comfort of the driver or the passenger.

### REFERENCE SIGNS LIST

100 motor drive system
1 motor control apparatus
11 frequency computation unit
12 coordinate conversion unit
13 current control unit
14 coordinate conversion unit
15 carrier frequency generation unit
15a first random number generation unit
15b call cycle determination unit
15c maximum average switching frequency determination unit
15d selection ratio determination unit
15e carrier frequency determination unit
15e1 second random number generation unit
15e2 frequency selection unit
16 carrier wave generation unit
17 PWM controller
2 motor
3 inverter
4 DC power source
5 DC voltage detector
6 phase current detector
7 magnetic pole position detector
21 transmission
22 differential gear
23 drive shaft
24 vehicle wheel(s)

1. A motor control apparatus for controlling an inverter that supplies AC power to an AC motor, the motor control apparatus comprising:
a carrier frequency generation unit that selects, based on a random number, each of a plurality of carrier frequency candidates at a predetermined ratio and that outputs the selected carrier frequency candidate as a carrier frequency;
a carrier wave generation unit that, based on the selected carrier frequency, generates a carrier wave; and
a PWM controller that outputs a PWM signal based on the carrier wave to an inverter,
wherein the predetermined ratio is determined based on the frequencies of the plurality of carrier frequency candidates and on a predetermined maximum average switching frequency.

2. The motor control apparatus according to claim 1,
wherein the carrier frequency generation unit includes an update cycle determination unit that randomly determines an update cycle of the selection.

3. The motor control apparatus according to claim 1,
wherein the carrier frequency candidates are binary.

4. The motor control apparatus according to claim 3,
wherein the predetermined ratio is calculated by the following formula:
$$\begin{matrix}[ Expression 1 ] & \\ {r}_{1} < \frac{{f}_{1} ( 1 \text{?} \frac{{f}_{2}}{{f}_{ave \_ max}} )}{{f}_{1} - {f}_{2}} & ( Formula 1 )\end{matrix}$$
$$\text{?} \text{indicates text missing or illegible when filed}$$
where f₁ is a first frequency, f₂ is a second frequency smaller than f₁, r₁ is a selection ratio of the first frequency, and f_{ave_max} is a maximum average switching frequency.

5. The motor control apparatus according to claim 1,
wherein the carrier frequency generation unit includes a maximum average switching frequency determination unit that, based on a rotational speed of the AC motor, a current value, or an element temperature of the inverter, determines the maximum average switching frequency.

6. An electric vehicle equipped with an AC motor, an inverter, and a motor control apparatus,
wherein the AC motor is a motor that drives wheels via a transmission, a differential gear, and a drive shaft, and
the motor control apparatus is the motor control apparatus according to claim 1.
